(19) United States
(12) Patent Application Publication
(10) Pub. No.: US 2013/0142913 A1
(43) Pub. Date: Jun. 6, 2013

(54) SANDWICH HAVING AN EDIBLE CASING LINK

(71) Applicants: Kyle B. Swigart, Madison, WI (US); Li An, Sun Prairie, WI (US); Randy Glynn, Fall River, WI (US)

(72) Inventors: Kyle B. Swigart, Madison, WI (US); Li An, Sun Prairie, WI (US); Randy Glynn, Fall River, WI (US)

(21) Appl. No.: 13/312,797

(22) Filed: Dec. 6, 2011

(51) Int. Cl. A23L 1/317

(52) U.S. Cl. 426/105; 426/646

(57) ABSTRACT

A food product having a pre-cooked loose meat filling along with a seasoning mix is provided in an edible casing. The edible casing is filled with the pre-cooked loose meat filling and the seasoning mix to produce a filled casing that is subsequently cooked to produce a meat link. The food product also may have a raw meat batter that is combined with the pre-cooked loose meat filling and filled into the edible casing along with the pre-cooked loose meat filling prior to subsequent cooking of the meat link. The pre-cooked loose meat filling may include discrete, not fully ground meat material including meat finely chopped, diced, chunks, shred, and splinters of meat. Alternatively, the pre-cooked loose meat filling may include cooked ground meat, though the pre-cooked loose meat filling will still have individual pieces larger than an emulsified product.

### TECHNICAL FIELD

This disclosure relates generally to sandwiches and, more particularly, to fillings for sandwiches.

### BACKGROUND

On-the-go consumption of food has increased over the years due to busy lifestyles and an increase in the variety of available convenient food options. On-the-go or convenience food items are those that may be consumed without conventional food preparation equipment and tools, such as a convection oven or certain utensils. In short, on-the-go food items are those that require little or no additional preparation by consumers and can be eaten shortly or immediately after purchase.

In addition to requiring little or no additional preparation, busy consumers often prefer on-the-go food items that are easily transportable and do not need to be eaten at the dinner table. Over the years, some foods have been rendered more easily consumed on-the-go due to their packaging or preparation. For example, packages with easy open features and packages that incorporate the accoutrements necessary for immediate consumption (i.e., a spoon for liquids or certain condiments) allow consumers to enjoy their foods shortly after purchase. Nonetheless, there remain several food items that do not easily render themselves for on-the-go consumption. For example, messy foods including those with lots of sauce or loosely bound ingredients are particularly difficult to eat on-the-go. Pulled pork and sloppy joe sandwiches are known for being difficult to eat when enjoyed at a dinner table and, thus, have previously been considered too messy for easy on-the-go consumption.

In the past, such messy foods including those with sauces, liquids, and loosely bound ingredients, were not considered good on-the-go convenience items, even though it was possible to prepare such foods for consumers such that little or no additional preparation would be required once purchased by a consumer. Therefore, while such food items are popular at sit-down establishments, they are not typically available where convenience, on-the-go foods are sold.

### BRIEF DESCRIPTION OF THE DRAWINGS

FIG. 1 comprises a top view of a first embodiment;

FIG. 2 comprises a cross sectional view of the embodiment of FIG. 1;

FIG. 3 comprises a cross sectional view of a second embodiment;

FIG. 4 comprises a perspective view of the embodiment of FIG. 3; and

FIG. 5 comprises a top plan view of a third embodiment.

Elements in the figures are illustrated for simplicity and clarity and have not necessarily been drawn to scale.

### DETAILED DESCRIPTION

Generally speaking, pursuant to these various embodiments, a food product such as a meat link has an edible casing that is filled with a first meat including a previously cooked or pre-cooked loose meat filling and a seasoning mix. As used herein, loose meat refers to discrete meat pieces that are not cohesively joined together. In addition, pre-cooked, as used herein, refers to meat that is fully cooked prior to being stuffed into an edible casing. The edible casing forms or links the pre-cooked loose meat filling and the seasoning mix into the food product having a shape. Once the edible casing is filled, the filled casing is subsequently cooked to produce a cooked meat link. A second meat, including a raw meat or raw meat batter, also may be added to the edible casing prior to subsequent cooking. The raw meat batter may be combined with the pre-cooked loose meat filling to form a combined meat mixture and then the edible casing may be filled with the combined meat mixture prior to being subsequently cooked. Even after subsequent cooking, the edible casing functions to retain the shape of the meat link. Due to the loose meat nature of the product described herein, if the edible casing is removed after subsequent cooking, the meat link generally fails to retain its shaped configuration. To this end and in one exemplary approach, the products herein may retain a degree of fluidity within the edible casing and, in some approaches, may resemble a barbeque or sloppy joe sandwich contained with the edible casing.

By one approach, a combined meat mixture used for the meat link may include about 5% to about 45% of the pre-cooked loose meat filling, about 15% to about 52% of the raw meat, about 0.5% to about 10% of the seasoning mix, and about 1% to about 25% of added water. The amount of the various ingredients in the combined meat mixture may depend on the desired final product. The combination is, at least in part, dependent on the desired texture (softness or firmness) of the resulting meat link. For example, the amount pre-cooked loose meat filling may be increased and the amount of raw meat decreased if a softer, looser texture is desired. Alternatively, the amount of pre-cooked loose meat filling may be decreased and the amount of raw meat increased if a firmer texture is desired, such as that typically found in hot dog links.

As another example, if a sloppy joe sandwich meat link is desired, the added water may be increased relative to some of the other ingredients, whereas for a pulled or shredded chicken sandwich meat link, less added water may be included in the combined meat mixture. More particularly, a sloppy joe sandwich meat link may have about 15% to about 25% added water, whereas a shredded chicken meat link may have about 1% to about 10% added water. As used herein, added water is the water that is in addition to the water present in the meat including the pre-cooked loose meat filling and the raw meat.

In another configuration, if a wet seasoning spice is included in the combined meat mixture, the seasoning mix may comprise about 5% to about 20% of the combined meat mixture. By another approach, if no raw meat is added to the combined meat mixture, the amount of the pre-cooked loose meat filling in the combined meat mixture may increase. In yet another example, if the food product includes both pre-cooked loose meat filling and raw meat, the pre-cooked meat and raw meat are typically both of the same type or species of meat. That is, the pre-cooked meat and the raw meat both include chicken or both include pork, for instance.

The pre-cooked loose meat filling may include a plurality of pre-cooked discrete meat pieces that are not fully ground including meat that has been chopped and diced, along with chunks, shreds, and splinters of meat, to note a few options. Alternatively, the pre-cooked loose meat filling may include a plurality of pre-cooked discrete meat pieces that are ground, such as granular, individual pieces of meat material that are larger than a finely ground, emulsified product. In sum, the pre-cooked loose meat filling may include a plurality of discrete pre-cooked meat pieces having a variety of sizes. By one approach, the pre-cooked loose meat pieces may have a size in the range of about ⅛ in. to about ½ in. In one example, the shreds or splinters of pre-cooked meat pieces, such as that used for a pulled or shredded meat link, may have a width of about ⅛ in. to about ¼ in. and also may have a variety of lengths. In another configuration, the meat link may include cubed or chopped pre-cooked loose meat pieces generally having a width of about ¼ in. to about ½ in. In yet another example, a meat link, such as a sloppy joe meat link, may have pre-cooked loose meat with a piece size of about ⅛ in. The plurality of discrete pre-cooked meat pieces may be individual and separate from one another such that they are not unified into a single cohesive mass of meat.

The pre-cooked loose meat filling in the food product includes protein. Because the pre-cooked loose meat filling is cooked, the proteins therein are typically denatured and less functional than proteins in the raw meat batter. For example, some meats, like beef and chicken, will become less red or pink when the proteins therein have been denatured. More particularly, the pre-cooked loose meat filling may be cooked to a temperate of up to about 155° F. to about 165° F. for a period of time (which depends on the meat being cooked) effective to set the protein bonds and denature the proteins to thereby render the pre-cooked loose meat filling fully cooked. Thus, when the pre-cooked loose meat filling is subsequently cooked or heated in the edible casing (after already having been fully cooked prior to filling into the casing), the plurality of discrete pre-cooked meat pieces in the pre-cooked loose meat filling do not fully bind with the other discrete pre-cooked meat pieces. Indeed, the pre-cooked loose meat filling generally retains its individual loose or discrete character and the edible casing is used to hold or bind the plurality of discrete pre-cooked meat pieces together. Furthermore, even if a raw meat batter is combined with the pre-cooked loose meat filling and subsequently cooked within the casing, the binding between the functional meat proteins of the raw meat batter is not sufficient to retain the shape of the food product without the edible casing. The pre-cooked loose meat filling may include poultry, pork, beef, fish, or a meat substitute or analog such as tofu or seitan, among others. If meat analogs are used, the pre-cooking process (including temperature and time) may be adjusted to account for the different ingredients.

By one approach, a raw meat batter is similar to an emulsion having a dispersed phase and a continuous phase. The raw meat batter may have finely chopped or finely ground raw meat particles and solid (and/or possibly some liquid) fat particles dispersed in a liquid continuous phase of water containing salts and proteins. While a true emulsion is typically two immiscible liquids, the term meat emulsion as it may be used herein refers to a mixture of solid fat particles dispersed in a liquid continuous phase. Furthermore, the meat proteins in the emulsion may serve as the emulsifying agent. To that end, the proteins surround the finely chopped fat particles to form a stable meat emulsion before cooking. By one approach, the raw meat batter may include about 15% to about 25% protein, about 60% to about 80% water, and about 5% to about 10% fat. The raw meat batter may be a mixture of different portions of a species. For example, the raw meat batter may include chicken breast, chicken thigh, and chicken skin. Thus, the combined raw meat batter may include about 15% to about 25% protein, about 60% to about 80% water, and about 5% to about 10% fat, though a specific portion of the raw meat batter may be comprised of ingredients, such as chicken skin, that are not within the above ranges. Since chicken skin typically has a composition of about 5% to about 10% protein, about 40% to about 45% water, and about 40% to about 50% fat, the raw meat batter generally does not have more than about 5% to about 10% chicken skin in the raw meat batter.

As mentioned, the pre-cooked loose meat filling is fully cooked prior to stuffing into the edible casing. It is considered less functional as an ingredient because the pre-cooking results in the proteins in the meat being denatured and extracted during the prior cooking step. On the other hand, the raw meat batter, because it includes raw meat, typically has available, functional proteins that can bind to other proteins. Thus, once the casing is subsequently cooked, if the casing includes both the pre-cooked loose meat filling and the raw meat batter, the available proteins of the raw meat batter will bind with one another to form a matrix thereof, but will not typically bind with protein in the pre-cooked loose meat filling. In addition, salt and other ingredients may be used to open up or make more proteins available for binding. To that end, the raw meat batter also may be mixed with additional ingredients such as water, flavorings, fat, food safety ingredients, and additional ingredients as needed for particular applications. When the raw meat batter is subsequently cooked, the available proteins will bind to one another to form the matrix around the pre-cooked loose meat filling as well as the additional ingredients such as water, flavorings, fat, and food safety ingredients, thereby trapping the additional ingredients in the meat once cooked. The pre-cooked loose meat filling does not generally have available proteins that can be opened up with salt or bound to other proteins and, therefore, does not have the same binding capabilities to the other proteins as the raw meat batter. Thus, even when subsequently cooked, the pre-cooked loose meat filling tends to retain its discrete nature such that the individual pieces are discernable within the meat link and the pre-cooked loose meat filling retains some ability to move within the matrix.

Meat proteins in the raw meat batter may have a limit to the amount of additional ingredients around which they can bind. Thus, there may be a limit to the amount of additional ingredients that can be added to the raw meat batter. When an amount of additional ingredients is added beyond which the meat proteins can bind, the meat is considered to be extended. By one approach, additional non-functional, non-meat ingredients of less than about 10% may be added to the raw meat batter before the raw meat becomes extended. A fully cooked meat, such as the pre-cooked loose meat filling, also becomes extended such that the addition of other ingredients such as water or flavorings would not be absorbed or trapped into the protein matrix because most of the available proteins have already bonded. Thus, the pre-cooked loose meat filling is generally considered extended and will have minimal opportunity to extend further.

As noted above, additional, non-meat ingredients, such as a portion of the seasoning mix, may be added or mixed with the raw meat to form the raw meat batter. Some additional ingredients, such as the added water, phosphate, and salt, are protein-binding functional ingredients because they are effective to improve binding of the meat proteins. Other additional ingredients, such as food safety ingredients perform other functionalities but are not generally considered protein-binding functional ingredients. For example, nitrites, which may function as a curing agent, and also as a food safety ingredient, may comprise less than about 1% of the combined meat mixture or about 120 to about 150 ppm. Some ingredients, such as phosphates, may perform both protein-binding functions and other functionalities. More particularly, phosphates may provide some level of textural control and phosphates also may help the meat protein bind to water or work to help fully utilize the protein. In one example, phosphates comprise less than about 1% of the combined meat mixture. By another approach, the phosphates comprise about 0.3% to about 0.5% thereof. The salt added to the mixture may comprise about 1% to about 3% of the combined meat mixture. In one example, the combined meat mixture includes about 2% added salt. Other additional ingredients may include starches or gums such as carrageenan. These may perform as thickening agents, but also may increase the binding potential of the meat protein or increase water holding capacity as well. Thus, these also may have dual functions. In one example, a starch is added to the combined meat mixture in the range of about 0.5% to about 3.0%. In another example, a gum, such as carrageenan, is added to the combined meat mixture in the range of about 0.1% to about 1.0%.

Other additional, non-meat ingredients that can be added to the raw meat batter may include non-functional ingredients, such as spices, cheese and vegetable pieces like jalapeños, onions, or pimentos, to note but a few options. These non-functional ingredients typically do not bind to the proteins in the meat and also do not greatly impact the binding capacity of the meat protein. By one approach, the pre-cooked loose meat filling may be considered a non-functional ingredient that does not bind with the available proteins from the raw meat batter during subsequent cooking. Like the water or flavorings around which the proteins in the raw meat batter bind to trap those ingredients, the non-functional ingredients, like pre-cooked loose meat filling, also may be secured or trapped within the matrix of the raw meat batter that is subsequently cooked. In short, the pre-cooked loose meat filling, which has been previously cooked and loses much of its meat protein functionality, becomes similar to other non-functional ingredients. Thus, once the edible casing is subsequently cooked, the raw meat batter may form a protein matrix around the pre-cooked loose meat and some of the additional ingredients without binding thereto.

The raw meat batter is more flowable than the pre-cooked loose meat filling and, when these ingredients are stuffed into the edible casing, the raw meat batter is able to at least partially surround the pre-cooked loose meat filling so that when the edible casing is subsequently cooked, the raw meat binds to itself around the pre-cooked loose meat filling resulting in a more cohesive food product. Nonetheless, the amount of raw meat batter filled into the edible casing is not sufficient to completely bind all of the ingredients within the edible casing. Indeed, the edible casing is employed to retain the various ingredients.

While the pre-cooked loose meat filling has denatured proteins, the proteins in the raw meat batter typically are not denatured and, thus, when the raw meat batter undergoes subsequent cooking, it binds together and at least partly solidifies into a solid or semi-solid form. The subsequent cooking operation of the meat link is generally done at a temperature of about 155° F. to about 165° F. for a period of time (which depends on the meat being cooked) effective to set the protein bonds and denature the protein, thereby rendering the raw meat batter fully cooked. Generally, the subsequent cooking operation will be performed in about 1 to about 3 hours. By one approach, the subsequent cooking operation is about 1.5 hours long. During the subsequent cooking operation, the pre-cooked loose meat filling is essentially cooked again or cooked a second time, along with the raw meat batter that is undergoing its first cooking operation. Nonetheless, during the subsequent cooking operation the degree of binding that occurs between the proteins of raw meat batter is not sufficient to have the food product retain its shape without the edible casing. By having pre-cooked loose meat filling portions mixed with the raw meat batter, the portions of the pre-cooked loose meat filling do not bind to the raw meat batter during subsequent cooking but retain some individual discrete character. The raw meat batter, however, will bind together and solidify around the pre-cooked loose meat filling similar to the way raw cookie dough binds around chocolate chip cookies during baking, though providing a bit more fluidity between the ingredients than found in a chocolate chip cookie. Therefore, after subsequent cooking of the edible casing, the pre-cooked loose meat filling generally retains its individual loose characteristics, though it has been loosely bound together by the raw meat batter that has been cooked. This binding effect works in addition to the binding accomplished by the edible casing that surrounds the food product.

The binding action of the raw meat batter that is subsequently cooked does not solidify the food product, though the subsequent cooking does change the raw meat batter from a liquid to a solid. The food product retains some fluidity between the various ingredients therein, even after the subsequent cooking. The discrete pre-cooked meat pieces, the seasoning mix, and the subsequently cooked raw meat batter are permitted some movement relative to one another because the proteins in the pre-cooked loose meat filling are generally not bound to the proteins in the subsequently cooked raw meat batter. More particularly, the interface between these ingredients is not fixed but instead retains some fluidity. This relative movement gives the food product a more loosely stuffed appearance, even after the subsequent cooking, though the edible casing is completely stuffed.

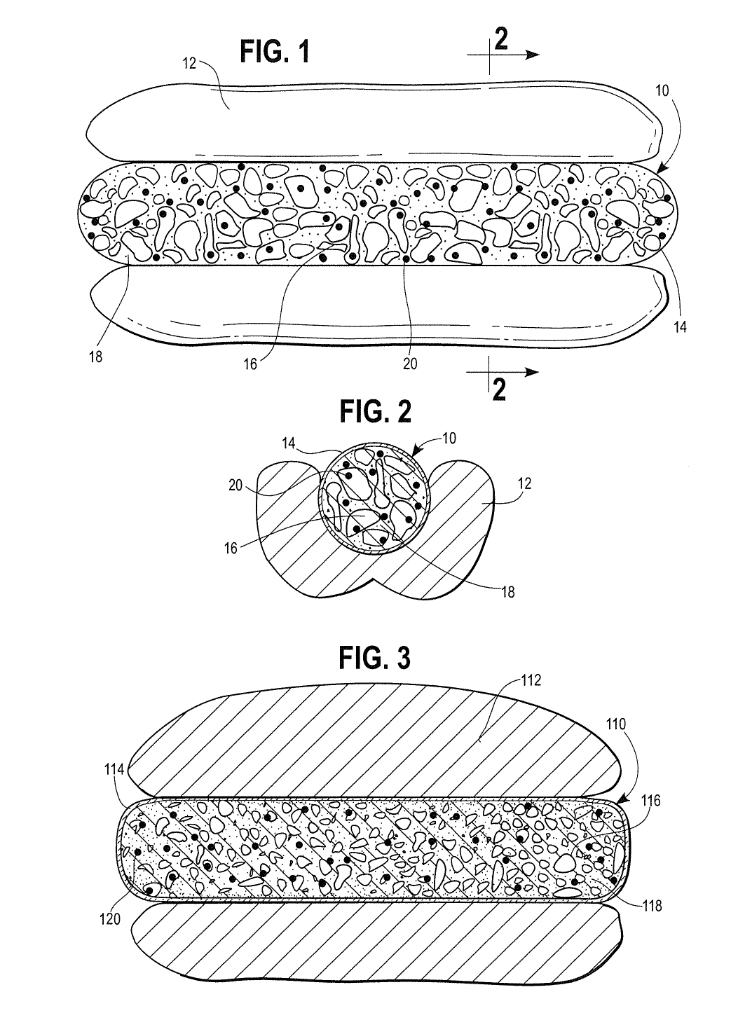

Referring now to the drawings, and in particular to FIG. 1, a top view of a food product 10 surrounded by bread or a bun 12 is shown. The food product 10 includes an edible casing 14 having a pre-cooked loose meat filling 16 and a flavoring or seasoning mix 20 therein. The edible casing 14 also may have a raw meat batter 18 blended therein. The raw meat batter 18 is uncooked when filled into the casing 14 (along with the pre-cooked loose meat filling 16 and the seasoning mix 20). The filled edible casing 14 is then subsequently cooked to form a meat link prior to consumption of the food product 10. In addition, the meat link may be cooled prior to shipment and delivery to consumers. Thus, the meat link may be cooked, grilled, or otherwise heated again just prior to consumption of the meat link. Since the meat link provided to consumers includes fully cooked meat and there are no proteins to be denatured, the consumer warming or heating operation does not require cook temperatures of 155° F. to about 165° F., such as those previously discussed. More particularly, the consumer may perform a heating or warming step prior to consumption of the meat link, but at this point, no proteins are denatured and the heating step primarily warms the meat link, as opposed to denaturing a significant number proteins. A number of warming mechanisms may be employed for the heating operation and include, for example, a roller grill, a grill, steam cooker, a crock pot, a microwave, and a heat lamp, to note but a few options. In one example, a roller grill is employed and heated to about 120° F. to about 155° F. for about 1 to about 1.5 hours prior to consumption of the meat link.

By having the pre-cooked loose meat filling 16 and the raw meat batter 18 that are filled into the edible casing 14 together and subsequently cooked, the food product 10 has at least two meat ingredients that have undergone different cooking processes. The proteins of the pre-cooked loose meat filling 16 are cooked and denatured prior to being filled into the edible casing 14, whereas the proteins of the raw meat batter 18 are denatured subsequent to being filled into the edible casing 14. Thus, initial cooking, where the proteins are denatured, occurs at two different times for the two different meat ingredients 16, 18 of the food product 10. Thus, since the pre-cooked loose meat filling 16 has been previously cooked prior to being filled into the edible casing 14 and then is subsequently cooked with the raw meat batter 18, the two meat ingredients have been cooked for different durations and, possibly, at different temperatures.

The pre-cooked loose meat filing 16 may include a plurality of pre-cooked discrete meat pieces that are not fully or finely ground, though it may be partially or coarsely ground. The pre-cooked loose meat filling 16 may include diced meat and chopped meat, along with splinters, shreds, and chunks of meat. The individual pre-cooked loose meat pieces may be a variety of sizes. In one approach, the shreds may be between about ⅛ in. to about ½ in. in size. As noted above, the meat piece size may depend on the desired final product.

In one illustrative embodiment, the raw meat batter 18 is an emulsified meat that is blended with a number of additional ingredients in addition to the meat protein. For example, the raw meat batter 18 may include raw meat, added water, salt, nitrite, phosphate, starch, and gum among other additional ingredients. In one embodiment, the raw meat batter may include about 1% to about 2.5% salt, about 124 to about 145 ppm of nitrites, about 1% to about 0.4% phosphates, and about 0% to about 3.0% water. By another approach, additional water may be added to provide the product with a wetter, runnier appearance. The raw meat batter 18 may have a slurry, liquid, doughy, or similar non-solid, flowable consistency when being mixed with the pre-cooked loose meat filling 16 prior to subsequent cooking. In one embodiment, a target percentage moisture or the amount of total water in the combined meat mixture before subsequent cooking is about 45% to about 60%, which includes the water contained in meat and other ingredients, along with the added water. Once the edible casing 14 has been filled and cooked, the raw meat batter 18 will bind and become a more solid or semi-solid meat product.

By one approach, the edible casing 14 is made of collagen. During cooking of the edible casing 14, the casing absorbs some moisture from the ingredients stuffed into the casing. The edible casing 14, prior to cooking, is somewhat papery in texture. Subsequent to cooking, the edible casing 14 becomes less papery and more flexible or rubbery, which is more appetizing to consumers than the papery texture of the uncooked casing. The edible casing 14 remains malleable after cooking and does not become stiff. Furthermore, the edible casing 14 may shrink a bit but the casing generally does not shrink significantly because the casing is filled with ingredients (such as the pre-cooked loose meat filling 16 and the raw meat batter 18) and the edible casing 14 does not provide much yield loss. It one illustrative embodiment, the edible casing 14 shrinks by less than about 2% of its weight and, in other approaches, the edible casing 14 may shrink between about 0.5% to about 3.5% of its size.

The food product 10 also may include the flavoring or seasoning mix 20. The seasoning mix 20 may enhance the meat flavor and, depending on the amount and type, may decrease the need for consumers to subsequently add condiments to the food product 10. By one approach, the seasoning mix 20 may be a dry spice. As used herein, a dry spice has no or very little water or other liquids added (such as less than about 1% moisture). It is anticipated that the dry spice may be a combination of a variety of ingredients. For example, the dry spice may include a buffalo spice, a teriyaki spice, a peppercorn spice, a barbeque spice, dried garlic, dried onion, red pepper, black pepper, ground mustard, paprika, salt, tumeric, and sugar, as well as combinations thereof to note a few of the numerous options. Other dry spices may include sweetener, nutmeg, ground flavoring powders such as chili pepper, chili powder, garlic and onion powders, as well as combinations thereof to note but a few. In addition, the dry spice may include some protein-binding functional ingredients such as salt and phosphate and food safety ingredients such as nitrite, ascorbate, and lactate, to note but a few. As mentioned above, the protein-binding functional ingredients typically improve the binding of the meat proteins. For example, the salt may open up the proteins of raw, functional meats and make them more readily available for binding with other raw meat, water, and other ingredients.

By yet another approach, the seasoning mix 20 may include a wet spice. The wet spice is primarily a flavor component and the amount of wet spice included in the product is largely a function of the desired final product. The wet spice may have the consistency of a paste, sauce, or liquid and may include a variety of ingredients including some of the dry spices mentioned above. The wet spice, for example, may include a variety of ingredients including a barbeque sauce, a honey barbeque sauce, a teriyaki sauce, a peppercorn sauce, a gravy sauce, a tomato sauce, a sloppy joe sauce, a chili spice sauce, a hot spice sauce, a buffalo sauce, a marinade, a mustard sauce, a honey mustard sauce, a condiment-based sauce, and an olive oil and garlic sauce, as well as a combination thereof, to note but a few of the many options. Additional flavor ingredients may also be added such as sugar, sweetener, paprika, pepper, artificial flavorings, oleoresin, nutmeg, and other ground flavoring powders, such as chili pepper, chili powder, garlic, and onion. Also, the wet spice may include finish product ingredients such as cheese, jalapeños, tomatoes, pickles, pimentos, olives, eggs, and onions, to note but a few. Alternatively, the finish product ingredients may be added subsequent to the addition of the wet spice ingredients.

By having the pre-cooked loose meat filling 16 and the raw meat batter 18 combined in the edible casing 14, the food product 10 acquires a texture that is generally soft such that after subsequent cooking the meat link appears loosely stuffed. As mentioned above, however, the meat link is completely stuffed but retains some fluidity between the ingredients therein. By adding a wet spice or a significant amount of added water into the combined meat mixture and into the edible casing prior to cooking, the food product retains an even greater degree of fluidity between the ingredients within the edible casing and the overall appearance of the food product 10 appears quite loosely stuffed. Further, the texture of the resulting food product includes more firm ingredients such as the pre-cooked loose meat filling 16 and softer ingredients such as the subsequently cooked raw meat batter 18 including the added water, and the wet spice, such that the end product is a food product 10 that appears to be a loosely stuffed meat link, though the edible casing 14 is entirely filled.

Further, the degree to which the edible casing 14 appears loosely stuffed is generally determined by the formulation of the ingredients and not by the stuffing process. To ensure a substantially fluid or loosely stuffed food product and to prevent the food product 10 from becoming a fully bound up meat link, the balance or ratio of the components including the pre-cooked loose meat filling 16, the raw meat batter 18, the seasoning mix 20, and any added water needs to be selected for the desired final product.

The generally soft texture of food product 10 typically requires that the edible casing 14 remain around the cooked food product 10 prior to consumption of the product if the particular shape is to be retained. For example, if the edible casing 14 is removed from the product after cooking, the meat link will not retain its shape and the contents of the link will not hold together in a link form but, instead, would fall apart or flatten out. Nonetheless, the generally soft texture of the cooked ingredients inside the edible casing 14 remain soft, loose, and crumbly such that the edible casing 14 is employed to retain the shape of the food product 10. In sum, the relative movement of the ingredients within the food product 10 give it a loosely stuffed appearance, though the edible casing 14 is full of ingredients. By one approach, the food product 10 is in link form and is about 0.2 lbs. after the subsequent cooking process. By another approach, the food product 10 may be about 0.1 to about 0.3 lbs.

As used herein, the edible casings 14 may include collagen casings such as manufactured collagen casings or natural casings. As used herein, the term “edible casing” denotes one that is intended for consumption by the consumer. By one approach, the edible casing shrinks less than about 5% to about 10% of its weight. By another approach, such as that for a longer casing with increased surface area, the edible casing may shrink about 0.5% to about 3.0%. By yet another approach, the edible casing shrinks less than about 2% of its weight. Further, the casing 14 generally comprises less than about 2% of the food product 10, whereas the combined mixture that is stuffed into the casing comprises about 98% of the food product 10. Thus, the food product 10 is primarily comprised of pre-cooked loose meat filling 16, the raw meat batter 18, and the seasoning mix 20 including any added water.

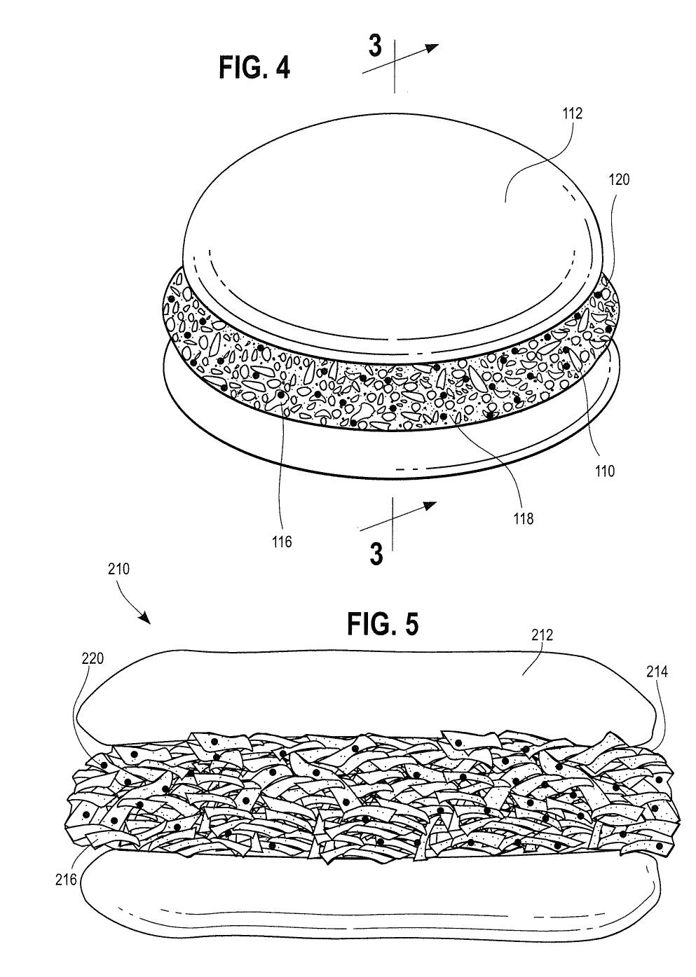

In one illustrative embodiment shown in FIGS. 1 and 2, the edible casing 14 is oblong in shape, similar to that used in a sausage link. Nonetheless, the edible casing 14 may be a variety of shapes and sizes such that the resultant meat link takes the shape of a patty or meat ball, among others. As noted above, the casing 14 typically produces a food product 10 that is about 0.2 lbs. after the subsequent cooking. In one approach, the length may vary but may be anywhere from about 4 to about 7 inches long and may have a diameter of about 0.25 to about 1.5 inches. By one approach, the food product 10 may be about 6 inches long and may have about a 1 inch diameter. As illustrated if FIGS. 3 and 4, a thinner and rounder food product 110 is shown, similar to that of a meat patty.

Food product 110, of FIGS. 3 and 4, includes pre-cooked loose meat filling 116 and a raw meat batter 118 in an edible casing 114. Compared to food product 10, food product 110 includes more pre-cooked loose meat filling 116 and has discrete pieces that are relatively smaller than those in food product 10. The relative amounts of the various ingredients may be adjusted to result in food products that have different texture profiles. For example, a sloppy joe meat link may have more finely chopped pre-cooked loose meat, whereas a pulled pork meat link may have larger discreet pre-cooked loose meat portions. In addition, having more raw meat batter relative to the pre-cooked loose meat results in a product with an increased cohesiveness and less fluidity between the various ingredients. Thus, if a more loosely bound food product is desired, less raw meat batter may be used, whereas if a more tightly bound food product is desired, additional raw meat batter may be used to increase the cohesiveness between the ingredients. Nonetheless, even with a larger amount of the raw meat batter 118, the amount of raw meat batter is not significant enough to create a meat link that can retain its shape after subsequent cooking without the edible casing.

By stuffing the pre-cooked loose meat filling, the seasoning mix, and the raw meat batter into an edible casing, the resulting food product may be consumed without concern that the food product will quickly begin to break or fall apart during consumption. The edible casing and the staged cooking of the meat ingredients permits the ingredients to remain loosely bound together during consumption. Further, the edible casing helps prevent dripping and loss of moisture, added water, or wet spices including sauces, though the edible casing does permit some cook off during the subsequent cooking operation as noted above.

Turning now to FIG. 5 illustrating a third embodiment, shown as food product 210. Food product 210 includes an edible casing 214 with a bun or bread 212 partially therearound. Within the edible casing 214, the food product 210 contains pre-cooked loose meat filling 216 that is relatively tightly packed when compared with the previous two embodiments. In addition to the pre-cooked loose meat 216, the edible casing 214 has a seasoning mix 220 that includes spices and other finished-product ingredients 240. The finished product ingredients 240 have significantly limited functionality and may include cheese portions, vegetable bits, and eggs, to note but a few of the other ingredients that may be added to the edible casing 214. Unlike the previous embodiments, food product 210 does not have raw meat batter mixed into the casing with the pre-cooked loose meat filling 216. Instead, the food product 210 relies almost exclusively on the binding capabilities of the edible casing 214 to retain or hold the ingredients together. More particularly, without the raw meat batter that is cooked to form a matrix around the pre-cooked loose meat filling 216, the edible casing 214 primarily retains the shape and form of the food product 210.

A method of making the meat links described herein may include several mixing steps. In a first mixing step, a portion of the raw meat (such as a lean raw meat having less than 30% fat), at least a portion of the seasoning mix, and a portion of the added water may be mixed together. This first mixing step may create a raw meat batter phase. In addition, the method also may include grinding or finely grinding the raw meat, such as turkey or chicken thigh, breast, or other raw meat, in a mixer. The seasoning mix including any functional and non-functional additional ingredients may be added to the ground meat, along with about ⅓ to about ½ of the added water. Alternatively, a portion of the seasoning mix may be added in the first mixing step and another portion of the seasoning mix may be added in subsequent operations.

After the first mixing step, any remaining added water and the remainder of the meat including any remaining raw meat and the fully pre-cooked meat are combined and then a second mixing step is performed. The second mixing step is generally shorter than the first mixing step. In another configuration, the second mix step may include only adding the rest of the raw meat, the balance of the additional ingredients and the rest of the water. In such a configuration, a third mixing step may be performed to add the pre-cooked loose meat ingredients. Though the method is described as having the lean raw meat mixed in the first mixing step and then additional raw meat added during the second mixing step, all of the raw meat may be added during the first mixing step. Subsequent to the mixing steps, the combined meat mixture may be stuffed into casings for the subsequent cooking operation, as described above.

The method also may include preparing, cooking, receiving, or obtaining the fully cooked meat so that no additional preparation is needed to form the fully cooked meat prior to combining it with the raw meat. If the fully pre-cooked meat is not in the desired meat piece size, the meat may need to be chopped, shredded, or otherwise prepared into the proper meat piece size prior to being mixed with the raw meat batter. Alternatively, the fully pre-cooked meat may already be formed into the desired size such that no further chopping or shredding is necessary.

In one illustrative embodiment, the raw meat batter 18 is prepared with a portion of the seasoning mix 20. More particularly, the raw meat of the raw meat batter 18 is mixed with protein-binding functional ingredients such as salt, phosphate, and water, along with other additional ingredients such as nitrites and starches. After the raw meat batter 18 is prepared, the pre-cooked loose meat filling 16 is added to the raw meat batter. Another portion of the seasoning mix 20 including flavor components and additional water may be added to the combined mixture. Then the combined mixture may be stuffed into casings.

The following non-limiting Examples are provided to illustrate embodiments of the food products described herein. However, the particular conditions, processing schemes, materials, and amounts thereof recited in these examples, as well as other conditions and details, should not be constructed to unduly limit the food product described herein. For example, though the below examples may outline how the pre-cooked loose meat 16 may be produced, it is also anticipated that this ingredient may be obtained already cooked such that those processing steps do not need to be conducted at the processing plant. All percentages are by weight unless otherwise indicated.

### EXAMPLES

### Example 1

In one illustrative example, shredded chicken links were produced. Chicken meat was cooked with a buffalo chicken flavor, chilled, and then the cooked chicken meat was shredded. The chicken was shredded into about 0.5 in. shreds. The shredded chicken was used as the pre-cooked loose meat filling. In example 1, about 30 lbs. of food product were produced. The pre-cooked loose meat filling included 13 lbs. of ground shredded chicken. The raw meat included 6 lbs. of ground chicken skin, and 6.9 lbs. ground chicken breast. Further, the combined meat mixture (pre-cooked loose meat filling and raw meat) included 2.5 lbs. of added water. The chicken in the raw meat batter was ground into about ⅛ in. pieces. The seasoning mix that was mixed with the raw meat included 0.5 lbs. of buffalo chicken flavor, 0.3 lbs. starch, 0.3 lbs. sugar, 0.3 lbs. salt, 0.03 lbs. sodium tripolyphosphate, and 0.4 lbs. sodium lactate.

To prepare the food product, a portion of the raw meat (the leaner portion), water, salt, sodium tripolyphosphate, and sodium lactate were mixed for about 5 min. Then, the remaining portion of the raw meat, starch, sugar and other flavorings, were added and mixed with the entire mixture for about 1-2 mins. to create the raw meat batter. After mixing, the pre-cooked shredded chicken was added and the entire mixture was mixed at the lowest speed to evenly distribute the ingredients. The mixture was then stuffed into a collagen casing and cooked to an internal cook temperature of 160° F. The cook cycle proceeded as follows: (1) 15 mins. with wet bulb and dry bulb temperatures of 120° F.; (2) 20 mins. with a wet bulb temperature of 115° F. and a dry bulb temperature of 135° F.; (3) 20 mins. with a wet bulb temperature of 125° F. and a dry bulb temperature of 150° F.; (4) 20 mins. with a wet bulb temperature of 145° F. and a dry bulb temperature of 165° F.; and (5) 10 mins. with wet and dry bulb temperatures of 170° F. The casings were generally about 6 inches long and the casings were fully stuffed. Since the food product only had about 2% cook off, the volume in the casing before and after subsequent cooking was similar. As used herein, cook off describes the loss in weight of the food product (such as by a loss in moisture through the casing) during subsequent cooking.

This example had about 43.3% pre-cooked loose meat filling, about 43% raw meat, 8.3% added water, and about 5.4% seasoning mix. The resulting buffalo chicken link exhibited a soft texture and good flavor, as evaluated through product observations. It also was observed that increased particle definition would be desirable for some applications. Furthermore, the edible casing retained the shredded buffalo chicken ingredients within the meat link and had the appearance of a loose meat product without having the ingredients separating from one another.

### Example 2

In this example, another shredded chicken link and about 30 lbs. of food product were produced. The pre-cooked loose meat filling in this example included 10.4 lbs. of cooked and shredded chicken prepared similar to the pre-cooked shredded chicken of Example 1. The fully cooked shredded chicken was combined with raw meat batter and seasonings. The raw meat included 4.7 lbs. of ground chicken skin, and 10.8 lbs. ground chicken thigh. Further, the combined meat mixture included 2.5 lbs. of added water. The seasoning mix included 0.5 lbs. of buffalo chicken flavor, 0.3 lbs. starch, 0.3 lbs. sugar, 0.3 lbs. salt, 0.03 lbs. sodium tripolyphosphate, and 0.4 lbs. sodium lactate. The food preparation process and cook cycle was performed as described with respect to Example 1 above.

By adding the ground chicken skin to the raw meat batter, the combined mixture had an improved meat emulsion or matrix. The fat in the food product increased by the addition of the ground chicken skin and the addition of that fat resulted in a better meat emulsion. Also, the ground chicken skin typically adds flavor that produces a more flavorful food product.

This example had about 34.7% pre-cooked loose meat filling, about 52% raw meat, about 8.3% added water, and about 6.1% seasoning mix. The resulting buffalo chicken link exhibited a very good texture and flavor and the edible casing retained the shredded buffalo chicken ingredients within the link to provide a meat product with the appearance of a loose meat without the risk of the ingredients separating from one another.

### Example 3

In this example, barbeque chicken links were made and about 30 lbs. of food product was produced. The pre-cooked loose meat filling included about 12 lbs. of cooked and shredded chicken, which was not ground. The fully cooked shredded chicken was combined with a raw meat batter than included water and finely ground chicken meat. The raw meat included 6 lbs. of ground chicken skin, and 6 lbs. of ground chicken thigh. The seasoning mix included 4 lbs. of barbeque sauce, 0.3 lbs. of sugar, 0.3 lbs. of salt, 0.03 lbs. of sodium tripolyphosphate, and 0.4 lbs. of sodium lactate. Further, the combined meat mixture included 1 lbs. of added water. The food preparation and cook cycle was performed as described with respect to Example 1 above; however, the shredded chicken was not ground. By not grinding the chicken in Example 3, the resulting food product retained more particle definition, as noted below.

This example had about 40% pre-cooked loose meat filling, about 40% raw meat, 3.3% added water, and about 16.7% seasoning mix. The resulting barbeque chicken link exhibited a few air pockets after subsequent cooking and chilling; however, after reheating the links, those air pockets disappeared. The barbeque chicken links exhibited a nice, soft texture. Further, by not grinding the shredded chicken, the links exhibited good particle definition between the shredded chicken and the raw meat batter that is subsequently cooked. The particle definition was sufficient to permit the visual identification of the different textural chicken components (i.e., the difference between the pre-cooked loose meat filling and the subseuquently cooked raw meat batter). The edible casing bound the ingredients together such that they do not separate from one another but the ingredients retained sufficient fluidity relative to one another to appear loosely bound.

### Example 4

Buffalo chicken links were produced. The pre-cooked loose meat filling included 20.6 lbs. of cooked and shredded chicken. The seasoning mix included 0.5 lbs. buffalo chicken flavor, and 0.6 lbs. of starch. Further, the combined meat mixture included 9 lbs. of added water. The total amount of food product produced was about 30.7 lbs. After the chicken was fully cooked and shredded, the seasoning mix, including buffalo chicken flavor, and starch, were added, along with the added water. The mixture was mixed in a paddle mixer. After adding the pre-cooked loose meat filling and the seasoning mix (including the added water) together, the batch was blended at the lowest speed for 1 to 2 mins., to result in an even distribution of ingredients. This example included 67% pre-cooked loose meat filling, 29.3% added water, and 3.6% seasoning mix.

The mixture was then stuffed into collagen casings and cooked. The cook cycle proceeded as follows: (1) 15 mins. with wet bulb and dry bulb temperatures of 120° F.; (2) 20 mins. with a wet bulb temperature of 115° F. and a dry bulb temperature of 135° F.; (3) 20 mins. with a wet bulb temperature of 125° F. and a dry bulb temperature of 150° F.; (4) 20 mins. with a wet bulb temperature of 145° F. and a dry bulb temperature of 165° F.; and (5) 10 mins. with wet and dry bulb temperatures of 170° F.

### Example 5

Buffalo chicken links were produced. The pre-cooked loose meat filling included 20.6 lbs. of cooked and shredded chicken. The seasoning mix included 0.4 lbs. of buffalo chicken flavor. Further, the combined meat mixture included 4.5 lbs. of added water. The total amount of food product produced was about 25.4 lbs. This example included 81% of the pre-cooked loose meat filling, 17.7% of the added water, and 1.6% seasoning mix. After the chicken was fully cooked and shredded, the seasoning mix including the water and buffalo chicken flavor were added. Then, the mixture was mixed, stuffed into casings, and cooked as described above with respect to Example 4.

### Example 6

Barbeque chicken links were produced. The pre-cooked loose meat filling included 21.0 lbs. of cooked and shredded chicken. The seasoning mix included 3 lbs. of barbeque sauce. The combined meat mixture included 3 lbs. of added water. The total amount of food product produced was about 27.0 lbs. This example included about 78% pre-cooked loose meat filling, about 11% added water, and about 11% seasoning mix. After the chicken was fully cooked and shredded, the seasoning mix was added to the cooked and shredded chicken. The barbeque sauce and water were mixed prior to combining them with the cooked, shredded chicken.

### Example 7

Buffalo chicken links were made and about 30 lbs. of food product were produced. The pre-cooked loose meat filling included 13.3 lbs. of cooked and shredded chicken. The seasoning mix included 0.5 lbs. of buffalo chicken flavoring, 0.2 lbs. salt, 0.01 lbs. sodium tripolyphosphate, and 0.6 lbs. of sodium lactate. In addition, a raw meat batter was combined with the cooked, shredded chicken. The raw meat batter included 4 lbs. of ground chicken skin and 9 lbs. of ground chicken. Further, the combined meat mixture included 2.7 lbs. of added water. This example included about 44% pre-cooked loose meat filling, about 4.3% seasoning mix, about 43% raw meat, and about 8.9% added water. Then, the mixture of the cooked chicken, seasoning mix, and raw meat batter was stuffed into collagen casings and cooked as describe above with respect to Example 4.

### Example 8

Buffalo chicken links were made and about 30 lbs. of food product was produced. The pre-cooked loose meat filling included 13 lbs. of cooked and shredded chicken. The seasoning mix included 0.5 lbs. of buffalo chicken flavor, 0.3 lbs. of starch, 0.3 lbs. of sugar, 0.3 lbs. of salt, 0.03 lbs. of sodium tripolyphosphate, and 0.4 lbs. of sodium lactate. In addition, a raw meat batter was combined with the cooked, shredded chicken. The raw meat batter included 4 lbs. of ground chicken skin and 8.9 lbs. of ground chicken. Further, the combined meat mixture included 2.5 lbs. of water. This example included about 43% pre-cooked loose meat filling, about 6.1% seasoning mix, about 43% raw meat, and about 8.3% water added. The mixture of the cooked and shredded chicken, seasoning mix, and raw meat batter was stuffed into collagen casings and cooked as described above with respect to Example 4.

### Example 9

Pulled pork links were made and about 28 lbs. of food product was produced. The pre-cooked loose meat filling included 12 lbs. of cooked and pulled pork. The raw meat included 10 lbs. of pork, which was ground to a particle size of 3/16 in. The seasoning mix included 2.9 lbs. of barbeque sauce and 0.3 lbs. salt, along with sodium lactate, sugar, starch and flavorings. Further, the combined meat mixture included 2.5 lbs. of water, which was partly in the form of ice chunks, at least when a portion of the 2.5 lbs. was combined with the raw meat. This example included about 43% pre-cooked loose meat filling, about 36% raw meat, 11.6% seasoning mix, and about 9% added water.

To prepare the food product, the raw meat batter and some of the seasoning mix ingredients were mixed for 3 mins. Then, the pulled pork and the remainder of the seasoning mix was added into the mixer and mixed for an additional 3 mins. The combined ingredients were then stuffed into collagen casings and cooked according to a cook cycles similar to that described above with respect to Example 1.

Those skilled in the art will recognize that a wide variety of modifications, alterations, and combinations can be made with respect to the above described embodiments without departing from the spirit and scope of the food product described herein, and that such modifications, alterations, and combinations are to be viewed as being within the ambit of the this disclosure.

1. A food product comprising:
a pre-cooked loose meat filling;
a raw meat batter having a ground raw meat suspended in a liquid, a seasoning mix, and added water; and
an edible casing, the edible casing filled with the pre-cooked loose meat filling, the seasoning mix, and the ground raw meat to produce a filled casing for subsequent cooking into a meat link;
the edible casing is effective to retain a shape of the meat link and wherein if the edible casing is removed after the subsequent cooking, the meat link does not retain its shape.

2. (canceled)

3. The food product of claim 1 comprising about 5% to about 40% pre-cooked loose meat filling; about 0.5% to about 10% seasoning mix; about 15% to about 40% raw meat; and about 1% to about 25% added water.

4. The food product of claim 3 wherein the added water includes about 15% to about 25% of the food product.

5. The food product of claim 3 wherein the added water includes about 15 to about 10% of the food product.

6. The food product of claim 1 wherein the raw meat includes about 15% to about 25% protein, about 60% to about 80% water, and about 5% to about 10% fat.

7. The food product of claim 1 wherein the pre-cooked loose meat filling may comprise at least one of:
poultry;
pork;
beef; and
meat substitute.

8. The food product of claim 1 wherein after the subsequent cooking the pre-cooked loose meat filling remains unbound to the raw meat such that relative movement is allowed between the pre-cooked loose meat filling, the seasoning mix, and the raw meat.

9. The food product of claim 8 wherein the edible casing shrinks by less than about 2% of its overall size during the subsequent cooking.

10. The food product of claim 1 wherein the raw meat is combined and filled into the edible casing with the pre-cooked loose meat filling prior to the subsequent cooking of the meat link.

11. The food product of claim 1 wherein the raw meat is an emulsified meat comprising at least one of:
poultry;
pork; and
beef.

12. The food product of claim 11 wherein the raw meat batter further includes at least one of:
a salt;
a nitrite; and
a phosphate.

13. The food product of claim 1 wherein the seasoning mix includes at least one of:
a dry spice; and
a wet spice.

14. The food product of claim 13 wherein the wet spice includes at least one of:
a barbeque sauce;
a honey barbeque sauce;
a teriyaki sauce;
a peppercorn sauce;
a gravy sauce;
a tomato sauce;
a sloppy joe sauce;
a chili spice sauce;
a hot spice sauce;
a buffalo sauce;
a marinade;
a mustard sauce;
a honey mustard sauce;
a condiment-based sauce;
an olive oil and garlic sauce;
functional ingredients;
cheese;
jalapenos;
tomatoes;
pickles;
pimentos;
olives;
egg; and
onions.

15. The food product of claim 13 wherein the dry spice includes at least one of:
a buffalo spice;
a teriyaki spice;
a peppercorn spice;
a barbeque spice;
dried garlic;
dried onion;
red pepper;
black pepper;
ground mustard;
paprika;
salt;
turmeric;
sugar;
sweeteners;
nutmeg; and
ground flavoring powders.

16. A method of making meat links comprising:
preparing pre-cooked loose meat filling;
grinding raw meat in a mixer;
mixing a seasoning mix and a first portion of added water to the ground raw meat;
mixing a second portion of added water and the pre-cooked loose meat filling;
stuffing a combined meat mixture including the pre-cooked loose meat filling, the raw meat, the seasoning mix, and the first and second portions of added water into an edible casings; and
cooking the combined meat mixture in the edible casings.

17. The food product of claim 1 wherein the edible casing is made of collagen.
